(19) United States
(12) Patent Application Publication
(10) Pub. No.: US 2026/0170367 A1
(43) Pub. Date: Jun. 18, 2026

(54) EXAMPLES: CAUSALITY SYNTHESIS MACHINE

(71) Applicant: DeftIO LLC, San Francisco, CA (US)

(72) Inventor: Manjirnath A. Chatterjee, Alameda, CA (US)

(21) Appl. No.: 19/390,483

(22) Filed: Nov. 14, 2025

Related U.S. Application Data
(60) Provisional application No. 63/720,698, filed on Nov. 14, 2024.

(51) Int. Cl. G06N 5/04; G06F 3/0485; G06F 21/16

(52) U.S. Cl. CPC G06N 5/042; G06F 3/0485; G06F 21/16

(57) ABSTRACT

Examples include a computing system and method for dynamically generating timeline visualizations and performing causality synthesis. In examples, input data is received from multiple sources of different states. Assertions are determined from the input data and the assertions are used to generate visualizations as described.

### CROSS-REFERENCE TO RELATED APPLICATIONS

This application claims the benefit of U.S. Provisional Patent Application No. 63/720,698, filed Nov. 14, 2024; the aforementioned application being hereby incorporated by reference in its entirety.

### FIELD OF THE INVENTION

Examples relate timeline and/or causality synthesis, and more specifically, to a system, method and computing device for timeline and/or causality analysis.

### BACKGROUND OF THE INVENTION

The field of event visualization and causality analysis encompasses tools and technologies that aim to present sequences of events in a format that facilitates understanding and analysis of temporal relationships and potential causality. Existing technologies in this domain, such as video timeline editors and other timeline visualization libraries, primarily focus on rendering events as a linear sequence with assumed veracity. These tools often assume that input data is factual and reliable, which poses a significant limitation when dealing with uncertain or conflicting data, such as witness testimonies or incomplete records, commonly encountered in domains like law enforcement, journalism, and historical analysis.

Traditional timeline visualization tools lack the capability to handle uncertain or unreliable data effectively. They tend to present a singular, assumed accurate account of events, thereby limiting the user's ability to explore varying scenarios or challenge the validity of the presented narrative. These tools also typically lack advanced features for integrating and visualizing data across different scales or formats, hindering their utility in comprehensive causality analysis where multiple types of time (chronological, state-based, or relative) might intersect.

### SUMMARY

The primary objective of the present disclosure is to provide a tool for generating rich interactive timelines for visualizing events across various contexts, such as news, personal events, and information corpuses, thereby enabling a deeper understanding of underlying relationships and sequences. This approach supports a nuanced understanding of causality where information might be fragmented or contradictory, offering a comprehensive view for forensic analysis.

Another objective of the present disclosure is to implement a system for performing causality analysis that treats all input data as assertions with varying degrees of reliability, rather than as facts. This advanced methodology allows for the exploration of multiple plausible timelines based on logical implications of these assertions, rather than being confined to fixed or unchangeable narratives, which broadens investigative capabilities.

Yet another objective of the present disclosure is to provide a visualization service for events over time, facilitating the analysis of dependencies between events, such as cause-and-effect relationships. This service provides a robust and intuitive user interface with continuous, slidable time sliders that align events across multiple bands, significantly enhancing user exploration of topics through temporal dimensions.

Still another objective of the present disclosure is to offer capabilities for investigating complex scenarios and problems across various fields, including criminal investigation and litigation. The system can generate visual aids, visualize timelines of involved parties and events, highlight discrepancies within core narratives, and model diverse scenarios to support or challenge existing narratives, thereby empowering investigators and other users with enhanced analytical capacities.

According to one objective of the present disclosure, a method for performing causality analysis is provided that comprises receiving input data, which includes news articles and IoT data. The method further involves determining a collection of assertions from the input data, where each assertion in the collection is associated with a reliability state. During an initial time interval, the value of the reliability state is configured to reflect that the assertion is unreliable. While each assertion is associated with the reliability state, the method proceeds by analyzing the assertion for reliability in relation to other assertions of the collection, and subsequently generating a visualization of one or multiple plausible timelines to identify and demonstrate potential causes and effects.

According to another objective of the present disclosure, a computer system is provided that comprises one or more processors and a memory for storing instructions. The one or more processors execute instructions stored in the memory to perform operations that include receiving input data, such as news articles and IoT data. The operations further include determining a collection of assertions from the input data, with each assertion of the collection being associated with a reliability state, wherein at least during an initial time interval, a value of the reliability state is set to reflect the assertion is unreliable. While each assertion is associated with the reliability state, the computer system analyzes the assertion for reliability in relation to other assertions of the collection and generates a visualization of one or multiple plausible timelines to identify and demonstrate potential causes and effects.

According to yet another objective of the present disclosure, a non-transitory computer-readable medium is provided, storing instructions that, when executed by one or more processors of a computing system or apparatus, cause the computer system or apparatus to perform operations. These operations include receiving input data comprising news articles and IoT data, and determining a collection of assertions from the input data, with each assertion in the collection associated with a reliability state. At least during an initial time interval, a value of the reliability state is set to reflect the assertion is unreliable. While each assertion is associated with the reliability state, the computer system analyzes the assertion for reliability in relation to other assertions of the collection, and generates a visualization of one or multiple plausible timelines to identify and demonstrate potential causes and effects.

In a particular aspect, generating the visualization further includes providing a user-interface for a computing device of a user, and presenting, with the user-interface, one or more of the multiple plausible timelines. The user-interface enables the user to interact with the device to record user annotations, facilitating personalized analysis and feedback within the timeline visualization.

In another aspect, the multiple plausible timelines encompass event time, relative time, and chronological time for events reflected by the collection of assertions. This comprehensive temporal representation caters to various analysis needs, allowing examination of events from different time perspectives for thorough investigation.

The method can further involve accepting untrusted data inputs and employing one or more machine learning algorithms to process these untrusted data inputs, suggesting plausible timelines among multiple possibilities. Additionally, user interaction is enabled for panning, zooming, and modifying scenarios that affect individual timelines as visualized on an interactive interface, thereby enhancing dynamic exploration. Furthermore, analyzed data can be exported for presentation, allowing findings to be shared and disseminated effectively.

The method also comprises facilitating note-taking and tagging on multiple scenarios, integrating electronic evidentiary data, and enabling probabilistic event handling to test conflicting assertions for veracity or reliability. These features contribute to a thorough and adaptable analytical environment, accommodating uncertain or disputed information effectively.

Determining a collection of assertions from the input data specifically involves identifying, from the input data, a collection of observations. These observations are then processed using a set of inference rules or logic to generate the collection of assertions, establishing a structured approach to deriving meaningful data.

In further elaboration, the set of inference rules or logic executes to infer causality between events identified in the collection of observations. This capability allows the system to discern causal links, enriching the analytical output with deeper relationship interpretations crucial for investigative or predictive purposes. The set of inference rules or logic can also incorporate machine-learning algorithms, leveraging advanced computational techniques for enhanced accuracy and efficiency in data processing and inference generation. Moreover, the set of inference rules or logic may include artificial-intelligence models or services, providing sophisticated analytical power for complex pattern recognition and decision-making within the causality analysis framework.

The method further involves generating each of the multiple plausible timelines based on the collection of assertions. This generation includes adjusting a scale of temporal units for individual timelines, allowing for flexible visualization tailored to the specific granularity and duration of events being analyzed.

Furthermore, the method contemplates identifying event occurrences within the plausible timelines and performing probabilistic event handling of the determined events. This enables robust analysis when dealing with uncertainties or incomplete information, providing a measured approach to understanding event sequences.

The disclosed system facilitates the exploration of complex, multi-dimensioned relationships between events while accounting for the inherent uncertainty in input data. It provides adaptability across vast temporal scales and integrates advanced analytical techniques for robust scenario generation. The foregoing paragraphs have been provided by way of general introduction and are not intended to limit the scope of the following claims. The described embodiments, together with additional advantages, will be best understood by reference to the following detailed description taken in conjunction with the accompanying drawings.

### BRIEF DESCRIPTION OF DRAWINGS

FIG. 1 illustrates an example computer system, according to one or more examples.

FIG. 2A and FIG. 2B illustrate examples of a user-interface on which embodiments generation interactive visualizations of timeline and/or causality synthesis, according to one or more embodiments.

FIG. 3 illustrates an example method for generating interactive visualizations for timeline generation and causality synthesis, according to one or more embodiments.

FIG. 4 is a block diagram that illustrates a computer system upon which one or more embodiments described herein may be implemented.

### DETAILED DESCRIPTION OF THE INVENTION

Aspects of the present disclosure are best understood by reference to the description set forth herein. All the aspects described herein will be better appreciated and understood when considered in conjunction with the following descriptions. It should be understood, however, that the following descriptions, while indicating preferred aspects and numerous specific details thereof, are given by way of illustration only and should not be treated as limitations. Changes and modifications may be made within the scope herein without departing from the spirit and scope thereof, and the present disclosure herein includes all such modifications.

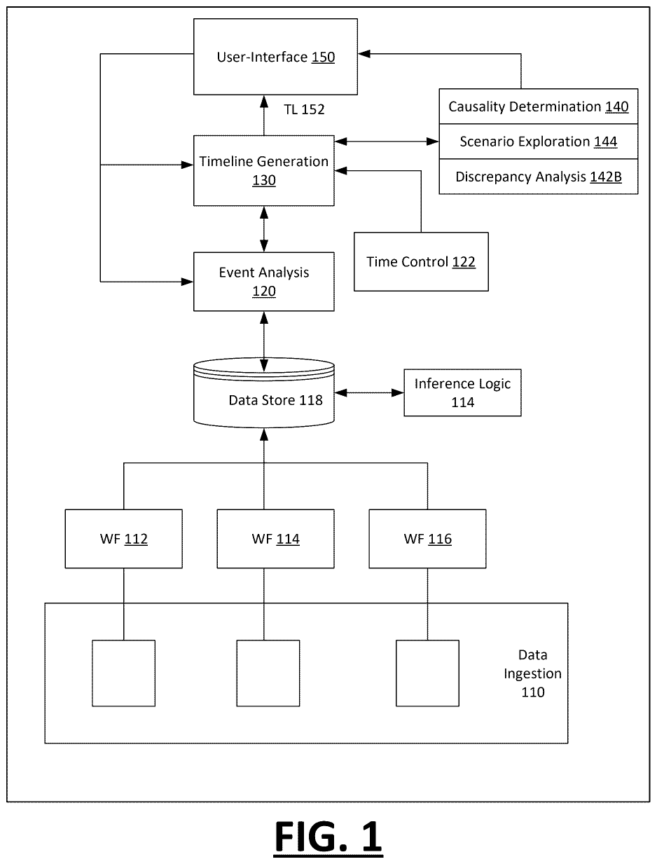

FIG. 1 illustrates a computer system on which examples are implemented. The computer

A network computer system 100 includes components and processes for implementing a data ingestion layer 110, workflow processes 112-116 for processing ingested data into text or tokenized data, and an intermediate data store 118. Further, the system 100 includes an event analysis component 120, a time control 122, a timeline determination component 130, and an interactive user-interface component 150. Different workflows 112, 114, 116 are implemented for different types of data and data sources. For example, text data can be tokenized and semantically analyzed, with optical character recognition (OCR) as needed. Image data (images, video, etc.) can be subjected to image recognition to identify objects, semantic meaning, labels, etc. Ingestion layer 110 can absorb, for example, video streams from network sources,, sensor data from sensors can be processed for data. External computers can be accessed over one or more networks for specific data that can be subjected to event analysis.

The ingested data, in normalized or raw form, can be stored in one or more specialized database 118. The corpus can be stored as a collection of record, where the collection of records include observations, assertions, and inferences. This is different than previous tools which accept these inputs as facts which then cannot be easily disputed. The workflows 112-116 can include machine learning tools to help identify observations and their associated to data, to gather event scenarios as timelines which can be explored, changed or exported for presentation. Other tools do not allow fuzzy inference in this way. This also allows data to be scaled from multiple disparate sources (e.g. different counties) when solving difficult causality problems like cold cases or disease spread. These tools allow exploration of time series and event data. As described with examples, the workflows 112-116 process the input data to determine information items, or “observations” as well as timing information and other contextual information.

Examples handles scenario generation and causality inference using machine learning tools by uniquely treating all input data as assertions with varying degrees of reliability rather than as absolute facts. This approach allows the system to create multiple plausible timelines based on the logical implications of these assertions. Traditional methods often rely on deterministic data inputs and present fixed, unchangeable timelines. Examples innovates by using probabilistic and fuzzy inference techniques to generate timelines that reflect the inherent uncertainty in real-world data.

Time control 122 configures timing parameters for scenarios implemented by the system 100. The timing parameters include the unit of time (e.g., fermasecond, picosecond, second, hour, year, etc.) or “time resolution” and the timeline range. The timeline range can also vary from small ranges (e.g., microseconds) to millions/billions of years, depending on the application or scenario. Time values can be formatted in a variety of formats and resolutions. In some examples, time is stored in a format that is compatible with JavaScript Date, allowing traditional calendar-based data. Examples High Resolution: 128-bit signed fixed-point integer for higher precision (down to approximately 10 zeptoseconds). In high resolution implementations or scenarios, a 224-bit fixed-point format providing extreme precision, useful for atomic-scale events. In the latter case, the time control 122 can implement atomic or universe scale event resolution.

Time data can be natively stored with various resolutions to support both common and specialized use cases. Standard Format: JS date-compatible. High-Resolution Storage: 128-bit signed fixed-point for precise second and fractional calculations. Extended Format: 224-bit signed fixed-point, represented as a 56-byte hex string for ultra-high precision. In this way, time control 122 can enable infinite resolution timescales, from femtoseconds to billions of years, and includes RESTful APIs for getting, adding, and deleting timeline event data. Time can be stored in multiple formats to allow precise measurement without losing accuracy.

The event analysis component 120 and/or time control 122 can also store open-ended events (e.g., events with an uncertain start or end date) and functional forms. Functional forms allow relationships like “before Event X” or “older_than Y” to be represented, enabling complex rule-based timelines.

The time control 122 also handles different kinds of time:
“time warped-time (Piecewise joined) tick based time (innings in a game) state based time (insect stages, cancer stages, other types of state-space events)−state−state-space/inferred-state (eg f(stuff)=stateX.

The time control 122 also provides chronological time scale resolution that varies the measurement or granularity of a temporal scale, from Planck time (the smallest measurable time unit) to universe scale time (billions of years). This allows examples to handle and plot time scales at any practical level, scientific of human.

In addition, time control 122 also enables probabilistic or untrusted time entries (e.g., without start/end time).

The user-interface 150 can be implemented by multiple components, including components or processes that employ filters and selection criteria. By way of example, geographic and data filters can be used that allow for advanced selection criteria. Users can narrow down events by location, time period, or custom metadata tags.

The event analysis component 120 can employ a variety of processes to detect, understand and evaluate events in a given corpus of information (e.g., as may be stored in the intermediate data store 118). The event analysis component 120 can generate assertions, through inferences of observations, and the assertions can be analyzed and subjected to discrepancy analysis 142B to determine assertions that are reliable.

The event analysis component 120 differentiates between certain and uncertain events. Observations are captured with uncertainty (e.g., someone says an event occurred at a specific time). This supports both hard data and inferred or probable events, enabling users to navigate through different confidence levels.

The event analysis component 120 can also include logic for determining causality and geographic representation. In implementation by the event analysis component 120, events can be causally linked to illustrate cause-effect relationships graphically. This feature helps users visualize how specific events influence others.

The event analysis component 120 can also include event interpolation logic to implement different interpolation methods to model continuous changes in numerical or discrete event data: Linear Interpolation Cosine Interpolation Custom Functions (e.g., windowing techniques such as Blackman-Harris for frequency analysis) Data Security and Privacy: For higher tiers, Examples includes advanced security features such as encryption of timeline data, secure on-premises deployment options, and access control mechanisms to protect sensitive information. User Experience: Highly interactive UI with minimal lag; multiple bands for different classes of events (e.g., people on separate bands); integrated maps and filters; support for continuous data (e.g., graphs of stock prices or temperature changes).

According to examples, input data (new articles, IOT data such as traffic signals or stock info) is obtained through the ingestion layer 110 and subjected to workflows that normalize data and generate a corpus of information for analysis. Depending on implementation, the ingestion can extract or receive data from disparate sources, such as IoT devices, electronic discovery records, witness statements, and news articles. The workflows 112-116 can also implement machine learning models and preprocess, as well as AI processes or services, to normalize this data to extract temporal markers, geospatial details, and event relationships while accounting for inconsistencies or gaps. The enhanced or augmented data set is then stored as a collection of records with the data store 118. In this way, the system 100 treats all incoming data (such as text, photos, traffic data, and IoT data) as observations, rather than definitive facts. Observations are subject to change, validation, and uncertainty. By focusing on this approach, system 100 allows users to explore causality, evaluate the reliability of data, and visualize multiple potential scenarios and timelines. Below, the key components of the system are detailed with technical descriptions to provide a better understanding of the underlying mechanisms.

In examples, the event analysis 120 analyzes the corpus of information for observations. The observations can range, such as for example, from witnessed events (Joe says he saw Johnny at the party at 9 pm), to sensor readings or news articles. and assigns those as assertions by observers. The event analysis component 120 detects observations, and initially, all observations are treated as unreliable. In implementation, each observation can be associated with a record in the data store 118, where the record includes content data (e.g., text of the observation) and a reliability state, where the reliability state includes a value that reflects the observation as reliable or unreliable. Initially, each observation is associated with a value that reflects it as being unreliable.

Timeline generation component 130 generates multiple plausible timelines 152 from the observations of the event analysis component 120. Additional analysis can be performed for causality determination 140 to determine probabilities of one event causing another event. The timelines 152 can be enriched with the causality determination. Timeline generation 130 and causality inference 140 can be implemented using, for example, machine learning tools and/or artificial intelligence tools, by uniquely treating all input data as assertions with varying degrees of reliability rather than as absolute facts. This approach allows the system to create multiple plausible timelines based on the logical implications of these assertions. Traditional methods often rely on deterministic data inputs and present fixed, unchangeable timelines. Examples innovates by using probabilistic and fuzzy inference techniques to generate timelines that reflect the inherent uncertainty in real-world data. Uncertainty-type analysis can include: (i) determining assertions from observations using rules and inference logic, and storing the assertions in the data store 118 with metadata reflecting their reliability, source, and contextual dependencies; (ii) using trained machine learning models to assess the probability of each assertion based on corroborating or conflicting data; (iii) using probabilistic graphical models or similar techniques, to identify multiple or all plausible event sequences that align with the given data; and (iv) dynamically generating plausible scenarios for the timelines, enabling users to explore “what-if” possibilities and adjust inputs to observe how outcomes shift. Users can interact with the user-interface component 150 to explore the what-ifs scenarios, causing real-time changes to the timeline and causality determinations.

In additional examples, the timeline generation component 130 and the causality determination 140 can use machine-learning algorithms, LLM models, or AI services to analyze event dependencies to infer causal links between actions and outcomes. Further, models can incorporate temporal proximity, corroborative patterns, or user-defined rules to determine timelines and causalities.

The timeline assertions allow logical paths and which are not possible (e.g. conflicting assertions can't be trusted). Discrepancy analysis 142 identifies conflicts with regards to occurrence of events, sequences and the like. The timeline generation 130, in combination with the event analysis component 120, builds what is termed support by visualizing which timelines are plausible and which are impossible by rendering the various assertions on a multi-time scaled visualization, presented through the user-interface 152. Examples as described treat each assertion identified from the input as being unreliable (e.g., associated with an unreliable state), meaning no “golden source” of information is assumed. Each assertion can, for example, be associated with a record and a reliability state, where the reliability state includes at least two values indicating “unreliable” or “reliable”.

The user-interface 150 can be interactive, and responsive in real-time to user events to manipulate generated timelines and absorb user input. The features of the user-interface 150 enable the users to explore and line up (including pan, zoom-in, and zoom-out) versions of sequences events to see which ones (especially conflicting ones) to see which should be trusted, which align, which are inconsistent. Portions of plausible timelines can thus be interactive and visual objects, manipulatable in appearance, content, position, size etc. and can also be overlayed or positioned side-by-side.

The user-interface 150 can also generate spatial representations, such as maps, that integrate (e.g., overlay or annotate) timelines based on the content or data associated with observations and events (e.g., stated locations, longitude/latitude of GPS coordinate, etc.).

Further, the user-interface component 150 can render multiple parallel timelines, allowing users to pan, zoom-in, zoom-out, and compare different scenarios in real time.

In examples, users can also export timelines 152 with detailed annotations and supporting data for use in presentations, court cases, or collaborative investigations.

Examples further provide for the event analysis component 120 and timeline generation component 130 to implement inferences and related logic, to generate hypotheses and hypothesis evaluation (e.g., probabilistic determination). In this way, the system can generate plausible event sequences and timelines with varying degrees of plausibility.

The system 100 also provides a user-interface 150 to render multiple parallel timelines and its support for annotations enable users to explore different scenarios, significantly enhancing the accuracy of causality analysis. This feature set allows for better investigation and presentation, particularly in situations where data integrity is uncertain, such as crime analysis, cold cases, or complex news events.

Examples further differentiates itself by supporting a wide range of time resolutions-from Planck time to universe scale-enabling precise analysis across diverse domains and timeframes. Its ability to manage bulk electronic discovery data and visualize this data alongside other sources greatly improves investigative efficiency, offering an innovative approach that surpasses ad hoc methods traditionally employed in such scenarios. Users can swiftly identify plausible sequences from large datasets, enhancing decision-making processes in contexts ranging from law enforcement to historical research.

With reference to FIG. 1, the incoming data is treated as observations. An observation is an instance where something is reported, either by a human observer or by a process (such as a sensor or automated data pipeline). Each observation is linked with a recorder, which is either a person or a process responsible for generating the observation. This data is structured as follows:
A recorder is the source of an observation. It could be a person, a digital sensor, a web scraper, or any other data-generating process. This metadata helps to contextualize the reliability of an observation and trace its origin. The recorder information is structured in the following format:
Recorder_Info:
name: <string> # Name of the person or process recording the observation (e.g., John Smith or Web Scraper 2.0)
recorder_type: <string> # Type of recorder (e.g., person, sensor, camera)
recorded_timestamp: <datetime> # When the observation was recorded (e.g., 2024-11-14T14:30:00Z)
recorded_location: <string> # Where the recording took place (e.g., Police Station, or IP address of the uploading device)
data: <string, file> # The data being recorded (e.g., picture, interview transcript, etc.)
event_timestamp: <datetime> # The date and time when the event purportedly occurred (this might differ from the recorded timestamp)

### Observation Information

The observation is data reported by a recorder. Observations include data about an event or an activity, along with a time range that could be subject to uncertainty. For example, a witness may claim that an event occurred around a specific time, which can be reconciled later as more data becomes available.

Observation:
observer_id: <string> # Identifier for the observer, either a name or UUID (e.g., JohnDoe123)
data: <string, file> # The actual observation data (e.g., “Billy was at the party”, or a picture)
time_begin: <datetime> # Start of the event (e.g., 2024-11-14T20:00:00Z, can be uncertain)
time_end: <datetime> # End of the event (e.g., 2024-11-14T23:00:00Z, can also be uncertain)
time_types: <array> # Types of time involved (e.g., chronological, relative, event-based)

The system 100 allows users to form assertions based on available observations and certain instructions. Assertions are conclusions generated by combining observations and applying certain rules or logic, as represented by inference logic 114. The inference logic 114 can be used to generate potential scenarios between assertions (events), as part of a plausible timeline. Inference logic 114 can be combined with other forms of logic to support causality analysis.

### Assertion Structure

Assertions can be thought of as hypotheses formed by processing observations using inference rules. Assertions include details about the conclusion drawn, the reasoning behind it, possible conflicts, and the strength of the assertion (e.g., how likely it is to be true).

Assertion:
observations: <array> # List of observations supporting the assertion (e.g., [obs1, obs2])
instructions: <string> # Rules or reasoning logic applied to generate the conclusion (e.g., “If witness1 and witness2 agree, increase confidence”)
conclusion: <string> # Generated conclusion (e.g., “Billy was present at the party”)
support: <string> # Reason why this conclusion is supported (e.g., “Multiple witnesses corroborate”)
conflicts: <string> # Reason why this conclusion may not be supported (e.g., “Camera footage contradicts witness”)
strength_of_conclusion: <numeric scale> # Numeric representation of how strong the assertion is (e.g., 0.8 on a scale from 0 to 1).

The following illustrates a framework implemented by processes of system 100, for determining plausible timelines and causality determinations;

### 1. Supported

Evidence is strongly aligned with the claim.
Observations overwhelmingly corroborate the claim.
Conflicting evidence is negligible or absent.
Degree of alignment is high and consistent.
Stability: Remains Supported unless significant new conflict appears.

### 2. Conflicted

Evidence contradicts the claim.
Observations specifically and repeatedly refute it.
Direct contradictions exist in core evidence.
The claim is incompatible with current data.
Stability: Stable negative state unless new positive evidence appears.

### 3. Indistinct

Evidence is insufficient or inconclusive.
Too few observations exist to evaluate the claim.
Data is low-resolution, noisy, or missing.
No strong support OR strong conflict exists.
Stability: Highly volatile; may shift as soon as new evidence arrives.

### 4. Mixed

Evidence is partially supporting and partially conflicting.
Some observations align; others contradict.
Often indicates perspective differences, incomplete data, or multi-actor complexity.
Useful for identifying ambiguity or contested domains.
Stability: May resolve toward Supported or Conflicted as evidence accumulates.

### How SCIM Enables Roll-Up From Evidence to Narratives

Below is the precise computational sequence enabled by SCIM. The key idea: SCIM is applied at every level, and each level becomes evidence for the next.

### Step 1—From Observations→Assertions

### Observations

Atomic units of recorded reality.
Each contains: entity, detail, context, evidence, source.
No interpretation beyond the recording itself.

### Process

Group related observations (same entity/detail/event).
Generate an Assertion that captures the claim implied by these observations.
Apply a SCIM scoring function to classify the assertion.

### Outcome

Each Assertion now has a SCIM state that reflects all available direct evidence.

### Step 2—From Assertions→Strongly-Supported Assertions (“Facts” to Most People)

I do not use Fact explicitly in the terminology, but conceptually this step refers to: Assertions with strong, stable SCIM=Supported (Verdict).

### Process

Identify Assertions whose SCIM state is Supported with sufficient evidence density, consistency, and low ambiguity.
These become high-confidence claims—the foundational truths for higher-level reasoning.

### Characteristics of Strongly-Supported Assertions

High alignment in Observations.
No significant contradictions.
Stable under incremental data updates.
Traceable to underlying Observations.

### Outcome

We now have a set of anchored claims—the building blocks of reliable narratives.

### Step 3—From Strong Assertions→Narratives

### Narrative Construction

A Narrative is constructed by linking Assertions into:
chronological sequences,
causal chains,
structured explanations,
or point-of-view descriptions.

### Narrative SCIM Evaluation

The Narrative inherits its SCIM state from its constituent Assertions:
High density of Supported Assertions→Supported Narrative
Conflict clusters→Conflicted Narrative
Sparse and low-confidence Assertions→Indistinct Narrative
Mixture of support and contradiction→Mixed Narrative Traceability

Narratives remain fully traceable:
Each Assertion points to its Observations
The Narrative points to all Assertions
The Timeline points to all Narratives

This enables full auditability and re-computation as new evidence arrives.

### Step 4—Narrative Roll-Up→Timelines→Knowledgebases

(You didn't ask for this step, but including it for completeness.)
Narratives are placed along a timeline.
Timelines feed into a Knowledgebase of consistent, SCIM-evaluated historical or analytical structures.

### Why SCIM Works for Computational Reasoning

Uniformity: Every layer uses the SAME four-state evaluation.
Composability: Higher-order states depend only on lower-level SCIM states.
Extensibility: SCIM scoring functions can be replaced dynamically (threshold, Bayesian, ML-based, hybrid).
Dynamism: SCIM states re-evaluate automatically as new Observations arrive.
Interpretability: SCIM provides a clean conceptual surface for visualization (graphs, etc.).

### Examples and Usage Scenarios

Examples in which a system such as described with examples can be implemented, include those described below.

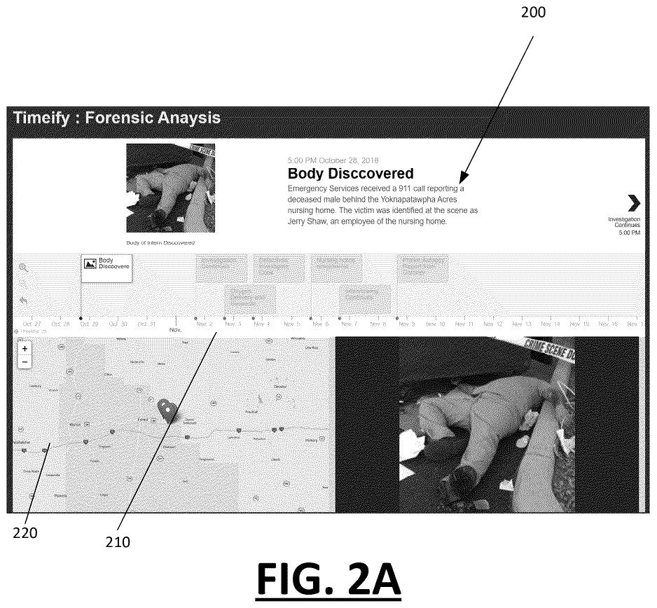

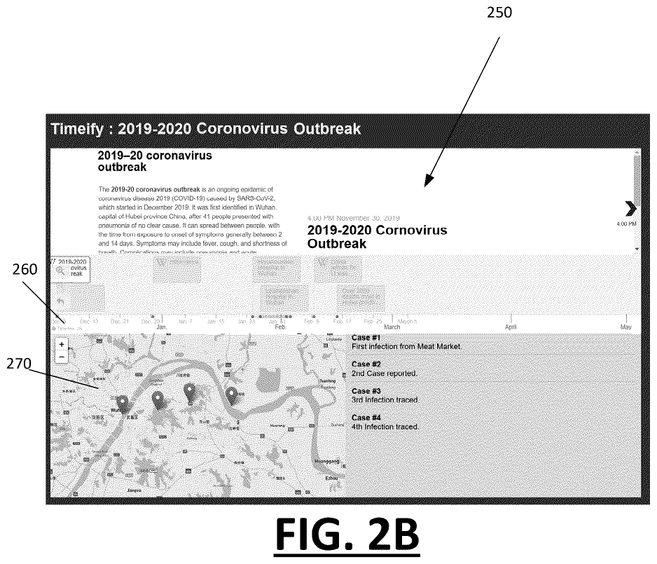

FIG. 2A and FIG. 2B illustrate examples of a user-interface on which embodiments generation interactive visualizations of timeline and/or causality synthesis, according to one or more embodiments. In describing the examples, reference is made to elements of FIG. 1 for purpose of components for performing functions as described. With reference to an example of FIG. 2A, an example system 100 can be used to generate an interface 400 representing a likely timeline of events. A detective investigating a series of burglaries across multiple neighborhoods can compile an information corpus by submitting electronically, reports, witness statements, and video footages. An example system can utilize different workflows based on the type of information being submitted. For example, the workflows can include Optical Character Recognition (OCR) to parse text in documents, image recognition to identify objects or text in images and video, and audio recognition to transcribe audio data. The example system c, they identify patterns in timing and locations that point to a common suspect. The tool's interactive maps help pinpoint areas with recurring incidents, while timeline analysis reveals potential links between events. As shown, the visualization of FIG. 2A provides the timeline 210 with accompanying geographic map 220 and event records.

An example system 100 can track the progression of disease outbreaks and visualize their spread across different regions. This is particularly useful for epidemiologists and public health officials who need to understand how a disease is transmitted and identify the sources of infection. With reference to an example of FIG. 2B, an example system 100 can be used to analyze viral outbreaks. During an outbreak of a new virus, system 100 can determine a timeline of events, and then generate content from aggregated information that is based on the timeline of events. An interface 250 can be used to generate the timeline of events, as well as the information items related to the timeline. The system 100 can generate the interface 250 to helps epidemiologists track initial cases, visualize hotspots on an interactive map, and overlay related events, such as public gatherings. This enables authorities to understand the impact of interventions (e.g., lockdowns or vaccinations) on the spread of the disease over time. As shown, the visualization provides the timeline 260 with accompanying geographic map 270 and event records.

### Additional Examples

An example system 100 can integration with news sites, to implement processes to assemble testimony, videos, and other evidence to understand key events from multiple points of view with live interactive synthesis. The users of the system 100 can include journalists that utilize system 100 to generate a comprehensive view of breaking news from multiple perspectives.

An example system 100 can create a personal timeline, integrating events from different aspects of life. Users can interact (e.g., via a user-interface) with a computer system to add their own events and data (entities), which can be linked using set-membership attributes (e.g., “Entity1 is a member of Entity2” or “Entity1 occurred before Entity2”) or custom user-entered rules.

In a law enforcement scenario, an example system 100 integrates data from interviews, videos (e.g., dash cams, body cams, security cameras), and metadata (e.g., weather, gunshots, receipts) to create a comprehensive timeline of events. The system can generate a user-interface that visualizes key moments and discrepancies in real time. For instance, in a criminal case, detectives can interact with visualizations, generated by the computer system, to reconstruct a suspect's movements and interactions across various locations and times, overlaying witness statements with video evidence. Examples can also help solve cold cases by connecting seemingly unrelated events across different jurisdictions.

An example system 100 can enable users explore key events throughout human history, from ancient civilizations to modern times. Users can zoom in on specific time periods and regions to see detailed events and their relationships. For example, the user can view events of WWII, specific battles, see events unfolding across different theaters (e.g., Pacific vs. European), and analyze how these events influenced each other.

In the context of information technology and cyber-security, an example system 100 can analyze the timeline of system errors, outages, and responses. This is particularly valuable for IT operations teams in identifying root causes and preventing future issues. To analyze a major system outage, for example, the system 100 can interface with servers of an affected system., to ingest logs and incident reports. By overlaying server logs, monitoring data, and incident reports, system 100 can identify the sequence of failures and determine that a recent software update caused the issue. In this way, the system 100 can implement causality analysis tools to identify and prevent similar problems in the future.

Further, the system 100 can interface with, for example, social media networks to generate timeline-based analysis of product sentiment, and brand sentiment and recognition. By way of example, product manager tracks customer satisfaction scores alongside product releases. They notice that satisfaction dropped after a specific update. Social media feeds can be fed into the system 100 to generate timeline-based overlays of user feedback, social media comments, and bug reports, they identify the new feature causing frustration and prioritize a fix.

Still further, as described with examples, the system 100 can support arbitrary timescale resolutions, with time resolution (e.g., based on the unit of time) and continuum (how long to extend time period, from seconds to billions of years depending on the application. Resolution and continuum can range from femtoseconds to billions of years, which makes it possible to analyze physical and geographic phenomena just as easily as human history.

In additional examples, an astrophysicist can use the system 100 to map cosmic events, from the formation of the first stars to present-day phenomena, enabling them to understand the evolution of the universe with precise timescales.

A researcher studying climate change can use the example system 100 to enter temperature records over centuries, using interpolation to estimate data gaps and visualize long-term trends.

In litigation, as a discovery tool, the system 100 ingests and handles bulk data of electronic discovery of records such as emails. Often during the discovery process millions of emails can be given to a plaintiff or prosecutor. The system 100 can improve upon existing discovery tools by adding them as events to be explored on a timeline which of course can be mixed with non e-discovery data as discussed.

In cold case investigations, the system 100 can ingest decades of fragmented data, including witness reports, geographic evidence, and digital records. By synthesizing this information, it could generate multiple timelines, highlight inconsistencies, and suggest plausible scenarios for further exploration. This would enable detectives to identify new leads or uncover overlooked connections.

### Methodology

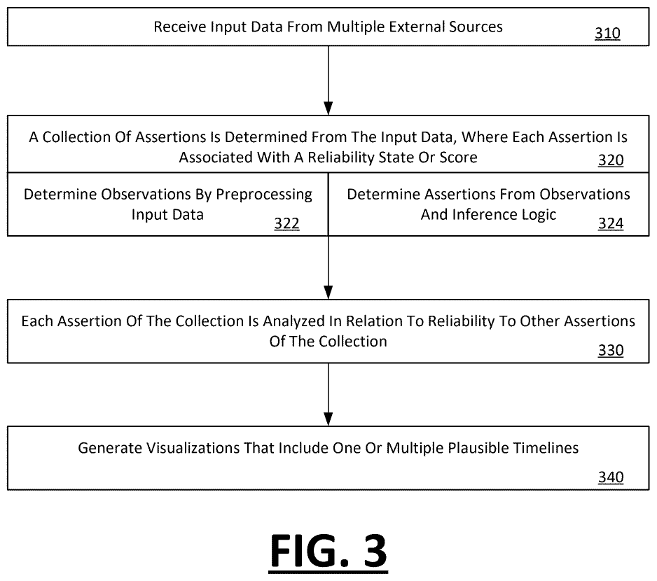

FIG. 3 illustrates an example method for generating interactive visualizations for timeline generation and causality synthesis, according to one or more embodiments. An example method such as described with FIG. 3 can be implemented by a computing system, such as described with examples of FIG. 1. Accordingly, reference is made to elements of FIG. 1 for purpose of illustrating suitable elements or components for implementing a step or sub-step being described.

In step 310, the computing system 100 receives input data for multiple external sources. The computing system 100 can access publications (e.g., from the publication source, such as a newswire, document library), images, video files and streaming data, audio data (e.g., voice memos, recorded programs, audio overlay of audiovisual content etc.), sensor data (e.g., environmental sensors), specialized devices, such as network appliances, traffic lights, Internet of things devices etc. and various other types of sources. In context of the e-discovery or medical applications, the computing system 100 can access collections of preassembled files and data items (e.g., patient files, including images, etc.). For each source data type that is access, the system 100 implements a workflow to convert or transform the access data into a normalized format that can be evaluated and analyzed against other data from other types of sources. For example, multiple workflows 112-116 can be implemented to transform input data into alphanumeric data, reflecting the content of information acquired, as well as metadata (e.g., timestamps) accompanying such information. For example, one type of workflow can process particular types of IoT data (e.g., traffic lights) or sensor data (e.g., temperature sensors). Other workflows can perform image recognition or optical character recognition (OCR), where recognized information is tokenized, scanned, and preprocessed. As a result of preprocessing, some examples provide for information items (e.g., events and observations) to be identified it extracted. The observations can include information about events and activities, as well as a range of time during which observations occurred. Observations, for example can be associated with corresponding records which are then stored in a database 118.

In step 320, a collection of assertions is determined from the input data, where each assertion is associated with the reliability state or score. Further, at least initially, each assertion is deemed unreliable, meaning the assertion is associated with the state or score the corresponds to the assertion being unreliable. By unreliable, the veracity or accuracy of the observation is assumed as unknown.

In determining assertion, sub-step 322 provides that observations can first be determined through a pre-processing step, performed by components of workflows 112-116. For example, input data multiple sources, of different types (e.g., sensor data, image data, text data etc.) can be processed to normalize format (e.g., alphanumeric data). At least portions of the data can then be tokenized to identify discrete information items or clusters of information items. Each observation can be associated with a record of the database 118. Furthermore, each observation can be associated with a reliability state or score, and initially, the reliability state or score of every observation (i.e., all observations) is set to reflect the observation as being unreliable.

In some examples, sub-step 324 determines a collection of assertions based on the determined observations using inference logic or rules. Assertions can be thought of as hypotheses formed by processing observations using inference rules and logic (e.g., models). Assertions include details about the conclusion drawn, the reasoning behind it, possible conflicts, and the strength of the assertion (e.g., how likely it is to be true). The collection of assertions can also be associated with a reliability state or score. Further, in at least some examples, during the initial time interval, each assertion (i.e., all of the assertions) reflect the assertion as being unreliable.

In step 330, each assertion of the collection is analyzed in relation to reliability to other assertions of the collection. The analysis can be performed while the assertions reflect it unreliable state or score. The determination of reliability can become progressively, through generation of output, user input, the implementation of inference logic, theory is a discrepancy analysis logic 142B, probabilistic determinations, recursive probabilistic determinations, graphs and the like.

In examples, the reliability analysis includes generating hypotheses that sequence observations and/or link observations as interdependent along a timeline. The computing system 100 can, for example, generate a plethora of hypothesis related to sequencing and interdependencies amongst observations, where links are identified through inference logic and rules. In some examples, the event analysis component 120 analyzes assertions in this manner, and runs every possible hypothesis where a sequence or dependency is identified between two or more observations. In some examples, a graph like structure is formed, where nodes represent observations, and links between nodes are identified by inferences and chronological information. The assertions can be evaluated as hypothesis that indicate a chronological sequence and/or interdependency as between observations. Each assertion can be promoted as reliable or unreliable, based on a totality and weight of observations and competing assertions which support or weaken the reliability determination. Thus, the reliability of each assertion, as reflected by corresponding assertions and their chronological and/or interdependent links to other assertions, is based on other assertions that weigh in support or against the assertions. A hypothesis, which can include a link (e.g., inference link) between observations, can be weighed/scored based on the number and/or weight of assertions that support the assertion versus the number and/or weight of assertions that weaken the hypothesis. Certain observations can be weighted to inherently reflect more or less value, based on, for example, the input data source, the type of data, historical patterns, or other analysis.

By way of example, an assertion that is based on image data can be weighed more heavily than an assertion that is based on eyewitness testimony. Likewise, biometric information can be weighed more heavily than image data. If image data shows a defendant was never at the scena, while DNA (biometric) information places the defendant at the scene, then the image data may be weighted down, even if it is supported by eye witness testimony that says the defendant was not seen.

Through such analysis, some examples identify probabilistic determinations that reflect a reliability score or state of a set of assertions. As determinations are made as to which assertions are likely unreliable, the assertions can be filtered out. The resulting assertions that are deemed reliable can then form a plausible timeline that can be visualized to the user.

In step 340, of the system 100 generates visualization that includes one or multiple plausible timelines to identify and demonstrate potential causes and effects. The possible timelines can be generated from those assertions which, through execution of reliability analysis, result in assertions that have a reliability state or score that reflects the assertion as reliable, or likely reliable. The timelines can be interactive, enabling individuals to zoom in, pan out, or otherwise manipulate the timelines, to generate annotations, notes and provide input that causes reevaluation a specific assertions in the timeline. For example a user can view the timeline, determining that a particular assertion is false based on information that is not available to the system 100, through interaction with the visualization provide input that indicates the assertion is being unreliable, and thereby causing the system 100 to regenerate one or more of the timelines to reflect the additional input of the user.

### Hardware System

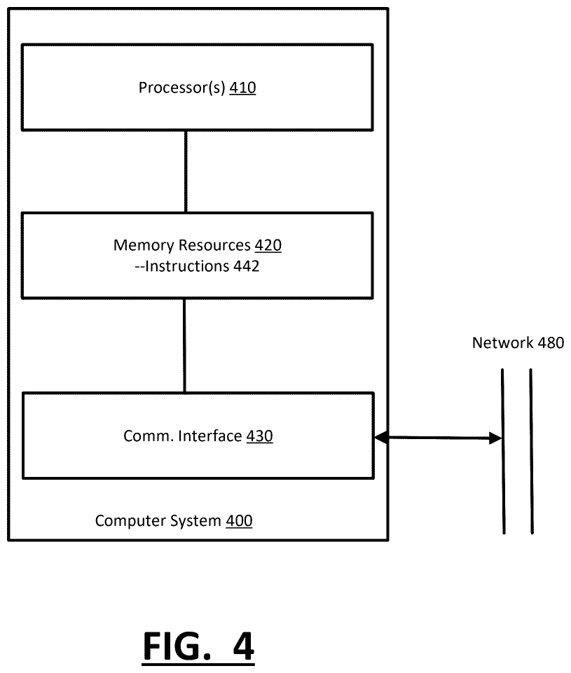

FIG. 4 is a block diagram that illustrates a computer system upon which one or more embodiments described herein may be implemented. For example, in the context of FIG. 1, the network computing system 100 may be implemented using a computer system of FIG. 4. Additionally, methods such as described with an example of FIG. 3 can be implemented using a computer system such as described with an example of FIG. 4.

In one implementation, the computer system 400 includes one or more processors 410, memory resources 420, and a communication interface 430. The computer system 400 includes at least one processor 410 for processing information. The memory resources 420 may include a random-access memory (RAM) or other dynamic storage device, for storing information and instructions to be executed by the processor(s) 410. The memory resources 420 also may be used for storing temporary variables or other intermediate information during execution of instructions to be executed by the processor(s) 410. The computer system 400 may also include other forms of memory resources, such as static storage devices for storing static information and instructions for the processor 410. The memory resources 420 can store information and instructions, including instructions 442 for implementing a timeline and/or causality synthesis machine, such as described with example system 100 of FIG. 1. Additionally, the processor(s) 410 can execute the instructions 442 to implement methods such as described with an example of FIG. 3.

The communication interface 430 can enable the computer system 400 to communicate with data sources of input data, over one or more networks 480 (e.g., cellular network) through use of the network link (wireless or wireline). Using the network link, the computer system 400 can communicate with one or more other computing devices and/or one or more other servers or data centers.

Examples described herein are related to the use of the computer system 400 for implementing the techniques described herein. According to one embodiment, those techniques are performed by the computer system 400 in response to the processor 410 executing one or more sequences of one or more instructions contained in the memory resources 420. Such instructions may be read into the memory resources 420 from another machine-readable medium, such as the storage device. Execution of the sequences of instructions contained in the memory resources 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

### Conclusion

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentione of the particular feature. Thus, the absence of describing combinations should not preclude having rights to such combinations.

The embodiments of the present disclosure as disclosed herein are intended to be illustrative and not limiting. Other embodiments are possible and modifications may be made to the embodiments without departing from the spirit and scope of the disclosure. As such, these embodiments are only illustrative of the inventive concepts contained herein.

What is claimed is:

1. A computer-implemented method for generating interactive visualizations, the method being implemented by one or more processors and computing:
receiving input data from multiple external sources;
determining a collection of assertions from the input data, each assertion of the collection being associated with a reliability state, and wherein at least during an initial time interval, a value of the reliability state is set to reflect the assertion as being unreliable;
while each assertion is associated with the reliability state in which the value indicates the assertion is unreliable, analyzing the assertion for reliability in relation to other assertions of the collection; and
based on determinations of reliable assertions, dynamically generating an interactive visualization of one or multiple plausible timelines to identify and demonstrate a sequence of events, and potential causal relationships and effects between the events.

2. The method of claim 1, wherein the multiple input sources include a first source of a first type, and a second source of a second type.

3. The method of claim 1, wherein the multiple input sources includes sources for providing published documents, audio/video streams, sensor data. and/or data transmitted from Internet-of-Things (IoT) devices.

4. The method of claim 1, wherein generating the visualization includes providing a user-interface for a computing device of a user, and providing, with the user-interface, one or more of the multiple plausible timelines, and enabling the user to interact with the user-interface to record user annotations.

5. The method of claim 1, wherein the multiple plausible timelines include event time, relative time, and chronological time, for events reflected by the collection of assertions.

6. The method of claim 1, further comprising:
accepting untrusted data inputs;
employing one or more machine learning algorithms to process the untrusted data inputs, and to suggest plausible timelines of the multiple plausible timelines; and
enabling user interaction for panning, zooming, and modifying scenarios that affect individual timelines as visualized on an interactive interface.

7. The method of claim 6, wherein the method further comprises:
exporting analyzed data for presentation.

8. The method of claim 1, wherein the method further comprises:
facilitating note-taking and tagging on multiple scenarios;
integrating electronic discovery data; and
enabling probabilistic event handling to test conflicting assertions for veracity and/or reliability.

9. The method of claim 1, wherein determining a collection of assertions from the input data includes:
identifying, from the input data, a collection of observations; and
processing the collection of observations using a set of inference rules or logic to generate the collection of assertions.

10. The method of claim 9, wherein the set of inference rules or logic execute to infer causality between events identified in the collection of observations.

11. The method of claim 9, wherein the set of inference rules or logic include machine-learning algorithms.

12. The method of claim 9, wherein the set of inference rules or logic include artificial-intelligence models or services.

13. The method of claim 1, further comprising:
generating each of the multiple plausible timelines based on the collection of assertions; and
wherein generating each of the multiple plausible timelines includes adjusting a scale of temporal units for individual timelines.

14. The method of claim 1, further comprising:
identifying event occurrences in the plausible timelines; and
performing probabilistic event handling of the determined events.

15. A computer system comprising:
one or more processors;
a memory to store instructions;
wherein the one or more processors execute instructions stored in the memory to perform operations that include:
receiving input data from multiple external sources;
determining a collection of assertions from the input data, each assertion of the collection being associated with a reliability state, and wherein at least during an initial time interval, a value of the reliability state is set to reflect the assertion as being unreliable;
while each assertion is associated with the reliability state in which the value indicates the assertion is unreliable, analyzing the assertion for reliability in relation to other assertions of the collection; and
based on determinations of reliable assertions, dynamically generating an interactive visualization of one or multiple plausible timelines to identify and demonstrate a sequence of events, and potential causal relationships and effects between the events.

16. A non-transitory computer-readable medium that stores instructions, which when executed by one or more processors of a computing system or apparatus, cause the computer system or apparatus to perform operations that include:
receiving input data from multiple external sources;
determining a collection of assertions from the input data, each assertion of the collection being associated with a reliability state, and wherein at least during an initial time interval, a value of the reliability state is set to reflect the assertion as being unreliable;
while each assertion is associated with the reliability state in which the value indicates the assertion is unreliable, analyzing the assertion for reliability in relation to other assertions of the collection; and
based on determinations of reliable assertions, dynamically generating an interactive visualization of one or multiple plausible timelines to identify and demonstrate a sequence of events, and potential causal relationships and effects between the events.
